(19) United States
(12) Patent Application Publication
(10) Pub. No.: US 2005/0257648 A1
(43) Pub. Date: Nov. 24, 2005

(54) Unidirectional buckling assembly of spanner

(76) Inventor: Chih-Ching Hsien, Taichung Hsien (TW)

Correspondence Address: CHIN-CHING HSIEN, 235 CHUNG-HO BOX 8-24, TAIPEI HSIEN, TW

(21) Appl. No.: 10/851,954

(22) Filed: May 24, 2004

(51) Int. Cl. B25B 13/46

(52) U.S. Cl. 81/59.1

(57) ABSTRACT

A unidirectional buckling assembly of a spanner comprise a spanner body having a receiving chamber at one end thereof; a toothless ratchet received a toothless ratchet; the toothless ratchet being received within the receiving chamber; a polygonal outer surface being formed at an outer surface of the toothless ratchet; a directional control groove formed aside the receiving chamber and near a handle of the spanner body; a directional control device received within the directional control groove; the toothless ratchet being buckled to the directional control device; the directional control device being formed by a directional control unit, and an elastomer which are placed in the directional control groove sequentially; a lateral side of the directional control unit protruding in the receiving chamber so as to be buckled to the polygonal outer surface of the toothless ratchet; and the elastomer resisting against the directional control unit.

### FIELD OF THE INVENTION

The present invention relates to a unidirectional buckling assembly of a spanner, wherein the ratchet wheel of the spanner has a polygonal outer surface so as to avoid the use of ratchet teeth. Only a directional control unit and an elastomer are used. The directional control unit and elastomer are sealed in the directional control groove. Thereby the assembly work is easy. Moreover, the elements of the unidirectional buckling assembly of a spanner according to the present invention can be updated quickly and conveniently.

### BACKGROUND OF THE INVENTION

Ratchet spanners are widely used. There are many different kinds of the ratchet spanners are developed for matching the requirement of users.

In one prior art of ratchet spanner, a teethed ratchet is engaged to a brake block. A spring is used to cause the ratchet to rotate unidirectionally. This is widely used in the prior art, but it is tedious to make such kind of spanner because the number of ratchet teeth is necessary to be formed. As a result, the cost is high. Thereby the assembly work is complicated.

In another prior art, a toothless ratchet is developed so as to achieve the object of buckling action of the ratchet wheel and a buckle element. Furthermore, this kind of spanner still needs completed machinery work. For example, a round hole for receiving spring is necessary, but this is difficult in the manufacturing work, but this will cause that the cost is increased.

### SUMMARY OF THE INVENTION

Accordingly, the primary object of the present invention is to provide a unidirectional buckling assembly of a spanner, wherein the ratchet wheel of the spanner has a polygonal outer surface so as to avoid the use of teeth. Only a directional control unit and an elastomer are used. The directional control unit and elastomer are sealed in the directional control groove. Thereby the assembly work is easy. Moreover, the elements of the unidirectional buckling assembly of a spanner according to the present invention can be updated quickly and conveniently.

To achieve above objects, the present invention provides a unidirectional buckling assembly of a spanner. The spanner comprise a spanner body having a receiving chamber at one end thereof; a toothless ratchet received within the receiving chamber; a polygonal outer surface being formed at an outer surface of the toothless ratchet; a directional control groove formed aside the receiving chamber and near a handle of the spanner body; a directional control device received within the directional control groove; the toothless ratchet being buckled to the directional control device; the directional control device being formed by a directional control unit, and an elastomer which are placed in the directional control groove sequentially; a lateral side of the directional control unit protruding in the receiving chamber so as to be buckled to the polygonal outer surface of the toothless ratchet; the elastomer resisting against the directional control unit. When rotating the spanner body, as the rotation of the spanner body cause that the directional control unit to compress the elastomer, the toothless ratchet will not rotate synchronously with the spanner body. When the rotation of the spanner body does not compress the elastomer, the toothless ratchet will rotate synchronously with the spanner body.

The various objects and advantages of the present invention will be more readily understood from the following detailed description when read in conjunction with the appended drawing.

### BRIEF DESCRIPTION OF THE DRAWINGS

FIG. 1 is a structural exploded view of the unidirectional buckling assembly of a spanner of the present invention.

FIG. 2 shows the operation of the present invention.

FIG. 3 shows another operation view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

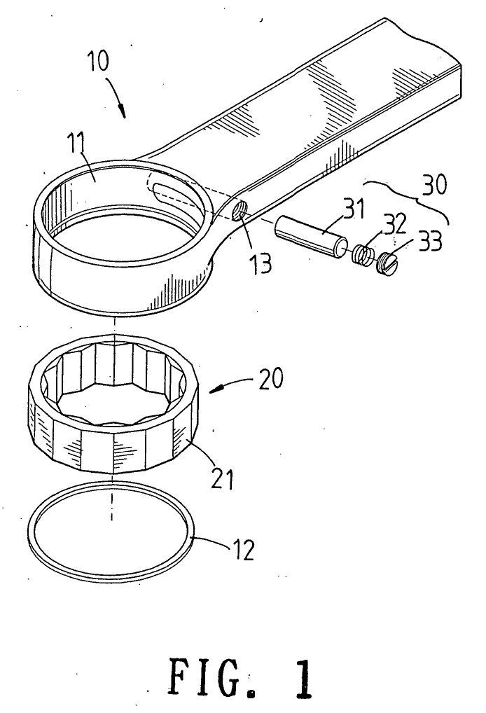

With reference to FIG. 1, the unidirectional buckling assembly of a spanner of the present invention is illustrated. In one preferred embodiment of the present invention, the unidirectional buckling assembly of a spanner comprise the following elements.

A spanner body 10 has a receiving chamber 11 at one end thereof for receiving a toothless ratchet 20. The toothless ratchet 20 is received within the receiving chamber 11 by a first sealing unit 12. A directional control groove 13 is formed aside the receiving chamber 11 and near a handle of the spanner body 10 for receiving a directional control device 30. The toothless ratchet 20 is buckled to the directional control device 30.

A polygonal outer surface 21 is formed at an outer surface of the toothless ratchet 20 for buckling the directional control device 30.

The directional control device 30 is formed by a directional control unit 31, an elastomer 32, and a second sealing unit 33 which are placed in the directional control groove 13 sequentially. The second sealing unit 33 serves to seal the directional control device 30 in the directional control groove 13. The directional control unit 31 is a round cylindrical post. A lateral side of the directional control unit 31 protrudes in the receiving chamber 11 so as to be buckled to the polygonal outer surface 21 of the toothless ratchet 20. The elastomer 32 resists against the directional control unit 31.

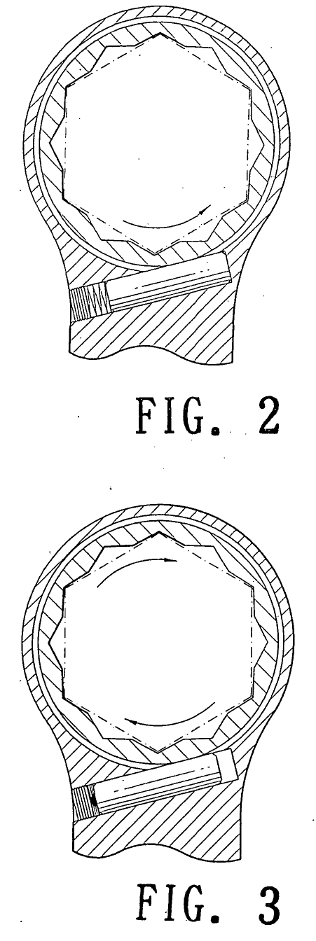

In use of the present invention, referring to FIGS. 2 and 3, since the toothless ratchet 20 is buckled to the directional control unit 31, when the spanner body 10 is rotated clockwise, the toothless ratchet 20 suffers from a first counterclockwise stress. The toothless ratchet 20 is buckled by the directional control unit 31 so as to rotate with the spanner body 10. When the spanner body 10 rotates counterclockwise, the toothless ratchet 20 will suffer from a clockwise stress which applies a horizontal force to the directional control unit 31 so that the directional control unit 31 resists against the elastomer 32. Thereby the elastomer 32 is compressed and thus the directional control unit 31 displaces in the end near the elastomer 32. As a result, the toothless ratchet 20 cannot rotate with respect to the spanner body 10.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A unidirectional buckling assembly of a spanner comprising:
a spanner body having a receiving chamber at one end thereof;
a toothless ratchet received within the receiving chamber; a polygonal outer surface being formed at an outer surface of the toothless ratchet;
a directional control groove formed aside the receiving chamber and near a handle of the spanner body;
a directional control device received within the directional control groove; the toothless ratchet being buckled to the directional control device; the directional control device being formed by a directional control unit, and an elastomer which are placed in the directional control groove sequentially; a lateral side of the directional control unit protruding in the receiving chamber so as to be buckled to the polygonal outer surface of the toothless ratchet; the elastomer resisting against the directional control unit;
wherein when rotating the spanner body, as the rotation of the spanner body cause that the directional control unit to compress the elastomer, the toothless ratchet will not rotate synchronously with the spanner body;
when the rotation of the spanner body does not compress the elastomer, the toothless ratchet will rotate synchronously with the spanner body.

2. The unidirectional buckling assembly of a spanner as claimed in claim 1, wherein the directional control unit is a round cylindrical post.

3. A unidirectional buckling assembly of a spanner comprising:
a spanner body having a receiving chamber at one end thereof
a toothless ratchet received within the receiving chamber by a first sealing unit; a polygonal outer surface being formed at an outer surface of the toothless ratchet;
a directional control groove formed aside the receiving chamber and near a handle of the spanner body;
a directional control device received within the directional control groove; the toothless ratchet being buckled to the directional control device; the directional control device being formed by a directional control unit, an elastomer, and a second sealing unit which are placed in the directional control groove sequentially; the second sealing unit serving to seal the directional control device in the directional control groove; a lateral side of the directional control unit protruding in the receiving chamber so as to be buckled to the polygonal outer surface of the toothless ratchet; the elastomer resisting against the directional control unit;
wherein when rotating the spanner body, as the rotation of the spanner body cause that the directional control unit to compress the elastomer, the toothless ratchet will not rotate synchronously with the spanner body; when the rotation of the spanner body does not compress the elastomer, the toothless ratchet will rotate synchronously with the spanner body.

4. The unidirectional buckling assembly of a spanner as claimed in claim 3, wherein the directional control unit is a round cylindrical post.
